(19) United States
(12) Patent Application Publication
(10) Pub. No.: US 2018/0243917 A1
(43) Pub. Date: Aug. 30, 2018

(54) ROBOT SYSTEM AND REMOTE CONTROL SYSTEM

(71) Applicant: KABUSHIKI KAISHA YASKAWA DENKI, Kitakyushu-shi (JP)

(72) Inventors: Fumihiko TAKEMOTO, Kitakyushu-shi (JP); Keita OGOH, Kitakyushu-shi (JP)

(73) Assignee: KABUSHIKI KAISHA YASKAWA DENKI, Kitakyushu-shi (JP)

(21) Appl. No.: 15/964,003

(22) Filed: Apr. 26, 2018

Related U.S. Application Data
(63) Continuation of application No. PCT/JP2015/082631, filed on Nov. 19, 2015.

(51) Int. Cl. B25J 13/00; B25J 9/00; B25J 9/16

(52) U.S. Cl. CPC B25J 13/006; B25J 9/1682; B25J 9/0081

(57) ABSTRACT

A robot system (1) according to the present disclosure includes: a robot (10#n); a controller (20#n) connected to the robot (10#n) via a wired line to control the robot (10#n); a first wireless device (30#n) connected to the controller (20#n) via a wired line; and a teaching device (50) configured to be capable of communicating with the first wireless device (30#n), capable of being grasped and operated by an operator (2), and controlling the robot (10#n) via the controller (20#n) in accordance with operation of the operator (2), in which a distance (D1) between a position where each robot (10#n) is arranged and a position where each controller (20#n) is arranged is longer than a distance (D2) between the position where each robot (10#n) is arranged and a position where each first wireless device (30#n) is arranged.

### RELATED APPLICATION

This application is a continuation application of international application PCT/JP2015/082631, filed Nov. 19, 2015, the entire contents of which are incorporated herein by reference.

### FIELD

The present disclosure relates to a robot system and a remote control system.

### BACKGROUND

A robot system is known that includes a robot, a controller to control the robot, and a teaching device (teaching pendant) to control the robot via the controller.

### SUMMARY

However, in the robot system, there has been a problem that ingenuity has not been made from a viewpoint of convenience of operation by an operator.

Accordingly, the present disclosure discloses a robot system and a remote control system capable of improving the convenience of operation by the operator.

A robot system according to a first aspect includes: a robot; a controller connected to the robot via a wired line, and configured to control the robot; a first wireless device connected to the controller via a wired line; and a teaching device configured to be capable of communicating with the first wireless device, capable of being grasped and operated by an operator, and configured to control the robot via the controller in accordance with operation of the operator. A distance between a position where the robot is arranged and a position where the controller is arranged is longer than a distance between the position where the robot is arranged and a position where the first wireless device is arranged.

A remote control system according to a second aspect includes: a controller configured to control a robot; a first wireless device connected to the controller; a teaching device capable of being grasped and operated by an operator, and configured to control the robot via the controller in accordance with operation of the operator; a second wireless device connected to the teaching device; and a belt for fixing the second wireless device around a waist of the operator. An antenna for communicating with the first wireless device is provided on each of the second wireless device and the belt. The second wireless device is connectable to the antenna provided on the belt.

According to the present disclosure, it is possible to provide the robot system and the remote control system capable of improving the convenience of operation by the operator.

### BRIEF DESCRIPTION OF DRAWINGS

FIG. 1 is a diagram for describing an example of an overall schematic configuration of a robot system according to an embodiment.

FIG. 2 is a diagram for describing an example of a hardware configuration of a first wireless device and a second wireless device of the robot system according to the embodiment.

FIG. 3 is a diagram for describing an example of a functional configuration of the first wireless device of the robot system according to the embodiment.

FIG. 4 is a diagram for describing an example of a functional configuration of the second wireless device of the robot system according to the embodiment.

FIG. 5 is a diagram for describing an example of an antenna provided on the second wireless device and a belt of the robot system according to the embodiment.

FIG. 6A is a diagram for describing an example of a hook portion provided on the second wireless device according to the embodiment.

FIG. 6B is a diagram for describing an example of the belt of the robot system according to the embodiment.

FIG. 7 is a diagram for describing an example of an appearance of the first wireless device of the robot system according to the embodiment.

### DESCRIPTION OF EMBODIMENTS

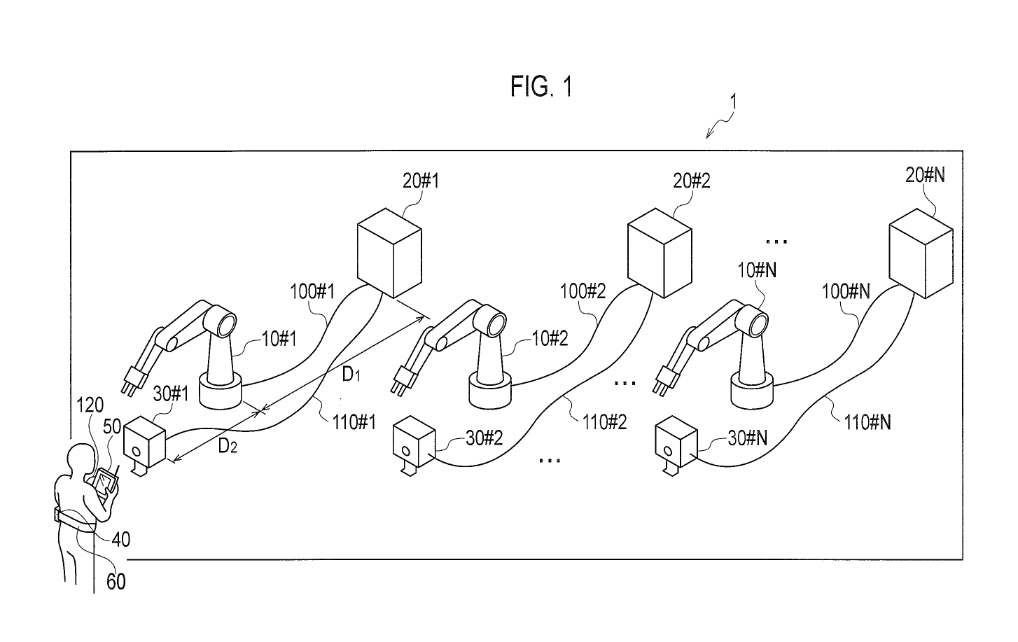

Hereinafter, one embodiment will be described with reference to FIGS. 1 to 7. As illustrated in FIG. 1, the robot system 1 according to the present embodiment includes a plurality of robots 10#n, a plurality of controllers 20#n, a plurality of first wireless devices 30#n, a second wireless device 40, a teaching device 50, and a belt 60. Here, n is an arbitrary integer in a range of 1 to N.

It is assumed that the robot system 1 according to the present embodiment is configured such that the number of robots 10, the number of controllers 20, and the number of first wireless devices 30 are identical to each other, and the robot 10#n, the controller 20#n, and the first wireless device 30#n having the same integer after “#” in the reference sign correspond to each other. Note that, the present disclosure is not limited to such a case, and is also applicable to a case where the number of robots 10, the number of controllers 20, and the number of first wireless devices 30 are not identical to each other.

The robot 10#n is configured to incorporate an actuator (for example, servomotor) for driving each joint axis, operate when the actuator is controlled by the controller 20#n corresponding to the robot 10#n, and perform various types of operation. Note that, a form of the robot 10#n may be a vertical articulated type, a horizontal articulated type, or a closed link type.

Each controller 20#n is configured to be connected to the corresponding robot 10#n via a wired line 100#n such as a cable and control the robot 10#n. Specifically, each controller 20#n is configured to control operation of the actuator of each joint of the corresponding robot 10#n.

Within the wire 100#n, a power line for supplying drive power to the actuator, a communication line for various sensors provided in association with the actuator for feedback control of the actuator, and the like are incorporated.

Further, each controller 20#n may include an emergency stop switch for emergently stopping the corresponding robot 10#n. In this case, an operator 2 presses the emergency stop switch at the time of emergency, thereby being able to cut off an actuator power source, a control power source, and the like of each joint of the robot 10#n in operation and immediately stop the robot 10#n.

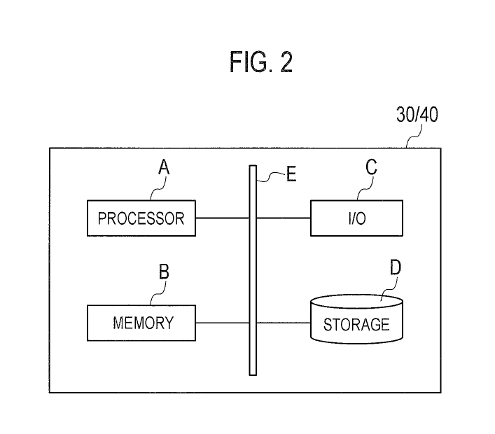

Each first wireless device 30#n is connected to the corresponding controller 20#n via a wired line 110#n. For example, as illustrated in FIG. 2, the first wireless device 30#n includes a processor A, a memory B, an input/output (I/O) C, a storage D, and a bus E mutually connecting the processor A, memory B, I/O C, and storage D. The processor A executes a program in cooperation with at least one of the memory B and the storage D, and performs input and output of data via the input/output C in accordance with the execution result. As a result, various functions of the first wireless device 30#n are achieved. Note that, the first wireless device 30#n need not include the bus E, and the memory B, the input/output (I/O) C, and the storage D may be directly connected to the processor A. Alternatively, the first wireless device 30#n may be configured to incorporate the processor A, the memory B, the input/output (I/O) C, and the storage D in a one-chip microprocessor.

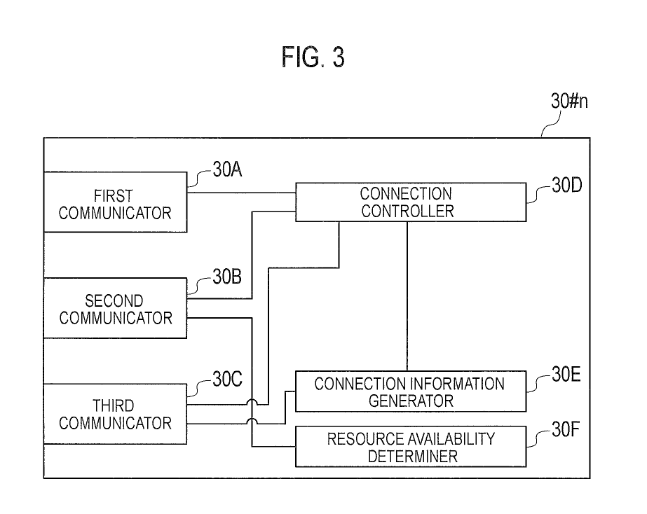

FIG. 3 illustrates those functions as virtual blocks (hereinafter referred to as function blocks). As illustrated in FIG. 3, the first wireless device 30#n includes a first communicator 30A, a second communicator 30B, a third communicator 30C, a connection controller 30D, a connection information generator 30E, and a resource availability determiner 30F.

The first communicator 30A is configured to perform communication using the first wireless communication scheme, the second communicator 30B is configured to perform communication using the second wireless communication scheme, and the third communicator 30C is configured to perform short-range communication.

The connection controller 30D is configured to perform control for connections (a connection of the first wireless communication scheme and a connection of the second wireless communication scheme) between the first wireless device 30#n and the second wireless device 40.

The connection information generator 30E is configured to generate information necessary for establishing the connection of the first wireless communication scheme and the connection of the second wireless communication scheme.

The resource availability determiner 30F is configured to monitor a status of use of resources used in the second wireless communication scheme and determine whether or not a predetermined wireless resource is available.

Here, the first wireless communication scheme is a communication scheme capable of transmitting a signal at an arbitrary timing using frequency hopping. For example, as the first wireless communication scheme, it is possible to use a communication scheme defined in the IEEE 802.15.1 standard, Bluetooth (registered trademark), or the like.

In addition, the second wireless communication scheme is a communication scheme of transmitting a signal in a case where it is determined that the predetermined wireless resource is available, that is, a communication scheme using a “Listen Before Talk (LBT)” technique. Here, the predetermined wireless resource means a time resource (time slot, time frame, or the like) to be used, a frequency resource (frequency band, frequency channel, or the like) to be used, or a code resource (spreading code, channelization code, or the like) to be used. For example, as the second wireless communication scheme, it is possible to use a communication scheme defined in the Wi-Fi standard or the like,

Specifically, the second communicator 30B is configured to perform communication of the second wireless communication scheme on the basis of a determination result by the resource availability determiner 30F.

Further, the third communicator 30C may be configured to perform communication using an optical communication means, for example, infrared communication defined in the IrDA standard or the like, as the above-described short-range communication.

For example, the first communicator 30A is configured to receive a control signal relating to drivability of the robot 10#n from the second wireless device 40 with the above-described first wireless communication scheme. Note that, as the control signal, a signal is assumed generated when an enabling switch, emergency stop switch, deadman switch, or the like to be described later is pressed.

In addition, the second communicator 30B is configured to receive an information signal relating to driving of the robot 10#n from the second wireless device 40, for example, with the above-described second wireless communication scheme.

Note that, in the robot system 1 according to the present embodiment, the first wireless device 30#n may be configured to include only one of the first communicator 30A and the second communicator 30B. That is, in the robot system 1 according to the present embodiment, the first wireless device 30#n may be configured to be capable of performing one system of wireless communication of the first wireless communication scheme or the second wireless communication scheme.

In addition, the third communicator 30C is configured to receive a predetermined signal to be described later from the second wireless device 40, for example, with short-range communication, and transmit common information to be described later to the second wireless device 40.

The teaching device 50 is configured to be capable of communicating with the first wireless device 30#n. The operator 2 can grasp and operate the teaching device 50. Here, the teaching device 50 is configured to control the robot 10#n corresponding to each controller 20#n in accordance with operation of the operator 2 via each controller 20#n. Note that, the teaching device 50 is also referred to as “Teaching Pendant”, “Programming Pendant”, or the like.

Specifically, the teaching device 50 includes a plurality of operation keys, a display screen, an enabling switch, and the like, and further includes an emergency stop switch similarly to the controller 20#n. Here, using the display screen as a touch screen, the display screen may be made to have functions equivalent to the operation keys by touching a software key displayed on the screen.

Note that, the teaching device 50 may have a mechanism referred to as a deadman switch. The deadman switch is provided at a position where the operator 2 grasps the teaching device 50 at the time of teaching operation or the like, and has a feature that operation to the teaching device 50 is valid only while the deadman switch is grasped by the operator 2. That is, even in a case where the operator 2 unintentionally presses an operation key, by invalidating the operation based on pressing of the operation key, a risk can be avoided that the robot 10#n suddenly moves or the like.

In the robot system 1 according to the present embodiment, the second wireless device 40 is a separate body from the teaching device 50, and is connected to the teaching device 50 via a wired line 120. Note that, the second wireless device 40 may be incorporated in the teaching device 50, may be integrated with the teaching device 50, or may be configured to be detachably attached to the teaching device 50. In addition, the second wireless device 40 is configured to wirelessly relay communication between the first wireless device 30#n and the teaching device 50.

For example, as illustrated in FIG. 2, the second wireless device 40 includes a processor A, a memory B, an input/output (I/O) C, a storage D, and a bus E mutually connecting the processor A, memory B, I/O C, and storage D. The processor A executes a program in cooperation with at least one of the memory B and the storage D, and performs input and output of data via the input/output C in accordance with the execution result. As a result, various functions of the second wireless device 40 are achieved. Note that, the second wireless device 40 need not include the bus E, and the memory B, the input/output (I/O) C, and the storage D may be directly connected to the processor A. Alternatively, the second wireless device 40 may be configured to incorporate the processor A, the memory B, the input/output (I/O) C, and the storage D in a one-chip microprocessor.

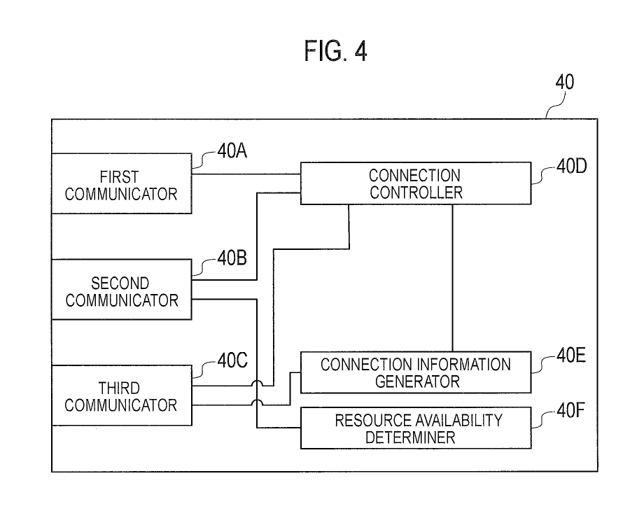

FIG. 4 illustrates those functions as virtual blocks (hereinafter referred to as function blocks). As illustrated in FIG. 4, the second wireless device 40 includes a first communicator 40A, a second communicator 40B, a third communicator 40C, a connection controller 40D, a connection information generator 40E, and a resource availability determiner 40F.

The first communicator 40A is configured to perform communication using the above-described first wireless communication scheme, the second communicator 40B is configured to perform communication using the above-described second wireless communication scheme, and the third communicator 40C is configured to perform the above-described short-range communication.

The connection controller 40D is configured to perform control for connections (the connection of the first wireless communication scheme and the connection of the second wireless communication scheme) between the first wireless device 30#n and the second wireless device 40.

The connection information generator 40E is configured to generate the information necessary for establishing the connection of the first wireless communication scheme and the connection of the second wireless communication scheme.

The resource availability determiner 40F is configured to monitor a status of use of resources used in the second wireless communication scheme and determine whether or not a predetermined wireless resource is available.

Specifically, the second communicator 40B is configured to perform communication of the second wireless communication scheme on the basis of a determination result by the resource availability determiner 40F.

For example, the first communicator 40A is configured to transmit the control signal relating to drivability of the robot 10#n to the first wireless device 30#n with the above-described first wireless communication scheme.

In addition, the second communicator 40B is configured to transmit the information signal relating to driving of the robot 10#n to the first wireless device 30#n, for example, by the above-described second wireless communication scheme.

According to this feature, there is an effect that the second wireless device 40 can appropriately transmit to the first wireless device 30#n a control signal requiring real-time property but having a small amount of information and an information signal having a large amount of information but low requirement for real-time property.

Note that, in the robot system 1 according to the present embodiment, the second wireless device 40 may be configured to include only one of the first communicator 40A and the second communicator 40B. That is, in the robot system 1 according to the present embodiment, the second wireless device 40 may be configured to be capable of performing one system of wireless communication of the first wireless communication scheme or the second wireless communication scheme.

In addition, the third communicator 40C may be configured to perform communication using an optical communication means, for example, infrared communication defined in the IrDA standard or the like, as the above-described short-range communication. Alternatively, the third communicator 40C may be configured to read a barcode, or may be configured to read an electronic tag such as a Radio Frequency Identifier (RFID) or Felica, or may be configured to read an ID card such as a Felica or SD card (registered trademark).

For example, the third communicator 40C is configured to acquire the common information to be described later from the first wireless device 30#n with the above-described short-range communication, and transmit the predetermined signal to be described later to the first wireless device 30#n.

As illustrated in FIG. 1, in the robot system 1 according to the present embodiment, a distance D1 between a position where each robot 10#n is arranged and a position where each controller 20#n corresponding to the robot 10#n is arranged is greater than a distance D2 between the position where each robot 10#n is arranged and a position where each first wireless device 30#n corresponding to the robot 10#n is arranged.

According to this configuration, there is an effect that each controller 20#n having a large installation area is arranged away from the position where each corresponding robot 10#n is arranged, whereby securing of an operation place of the operator 2 is made easy, and each first wireless device 30#n is arranged near the position where each corresponding robot 10#n is arranged, whereby communication can be reliably performed between the teaching device 50 and each first wireless device 30#n.

In addition, as illustrated in FIG. 1, in the robot system 1 according to the present embodiment, arrangement order of the robot 10#n may be arranged to be identical to arrangement order of the first wireless device 30#n corresponding to each robot 10#n.

According to this configuration, there is an effect that the operator 2 can easily recognize the first wireless device 30#n corresponding to the robot 10#n to be controlled, and can accurately control the robot 10#n by using the teaching device 50.

In addition, in a case where the third communicator 40C of the second wireless device 40 (or the teaching device 50) transmits the predetermined signal to the first wireless device 30#n via the above-described short-range communication, a new connection may be established between the first wireless device 30#n and the second wireless device 40 (or the teaching device 50) by the connection controller 30D of the first wireless device 30#n and the connection controller 40D of the second wireless device 40 (or the teaching device 50).

According to this configuration, a connection is established by short-range communication between the second wireless device 40 (or the teaching device 50) and the first wireless device 30#n, and then communication is performed via the connection, so that the second wireless device 40 (or the teaching device 50) can correctly communicate with the first wireless device 30#n corresponding to the robot 10#n to be controlled.

Alternatively, in the robot system 1 according to the present embodiment, in a case where the predetermined signal is transmitted by the second wireless device 40 (or the teaching device 50) as described above, new connections may be established after an existing connection is disconnected by the connection controller 30D of the first wireless device 30#n and the connection controller 40D of the second wireless device 40 (or the teaching device 50).

According to this feature, there is an effect that, with one trigger, it is possible to establish the new connection after disconnecting the existing connection, and it is possible to establish the new connection while disconnecting the existing connection that is no longer to be used without using a complicated procedure.

In addition, in the robot system 1 according to the present embodiment, the above-described connection may be established on the basis of the common information (for example, unique identification information of the first wireless device 30#n) acquired from the first wireless device 30#n by the second wireless device 40 (or the teaching device 50) via short-range communication. Note that, the unique identification information of the first wireless device 30#n used for pairing between the first wireless device 30#n and the second wireless device 40 is stored in the first wireless device 30#n, and is transmitted to the second wireless device 40 and used.

For example, the above-described connection may be established on the basis of a Service Set Identifier (SSID) generated on the basis of the unique identification information of the first wireless device 30#n.

That is, the connection information generator 30E of the first wireless device 30#n and the connection information generator 40E of the second wireless device 40 are configured to generate the SSID on the basis of the common information (for example, unique identification information of the first wireless device 30#n), as information necessary for establishing the above-described connection.

According to this feature, there is an effect that on the basis of the common information (for example, unique identification information of the first wireless device 30#n) common to the first wireless device 30#n and the second wireless device 40, the information is generated necessary for establishing the above-described connection, whereby a procedure for determining the information can be simplified.

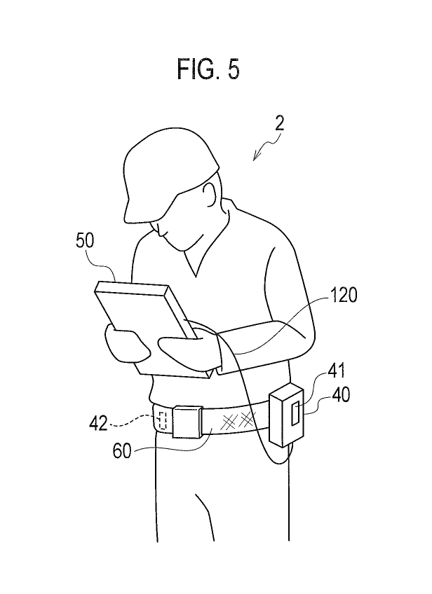

In addition, as illustrated in FIG. 5, in the robot system 1 according to the present embodiment, the belt 60 is for fixing the second wireless device 40 around the waist of the operator 2. Here, as illustrated in FIG. 5, as an antenna for communicating with the first wireless device 30#n, an antenna 41 is provided on the second wireless device 40, and an antenna 42 is provided on the belt 60.

The antenna 41 may be incorporated in the second wireless device 40 as illustrated in FIG. 5, or may be provided outside the second wireless device 40. Similarly, the antenna 42 may be incorporated in the belt 60 as illustrated in FIG. 5, or may be provided outside the belt 60. Here, the second wireless device 40 is configured to be connectable to the antenna 42 provided on the belt 60.

Note that, as a shape of the antenna 41 and the antenna 42, any shape can be used, such as a linear antenna, a planar antenna, or a plate-like antenna. In addition, an installation position of the antenna 42 can be any position on a belt as long as the installation position is a position where the antenna 42 can form a diversity configuration with the antenna 41.

According to this configuration, there is an effect that even in a case where the operator 2 takes a posture of obstructing communication between the second wireless device 40 and the first wireless device 30#n, by the antenna 42 provided on the belt 60, the communication can be continued between the second wireless device 40 and the first wireless device 30#n.

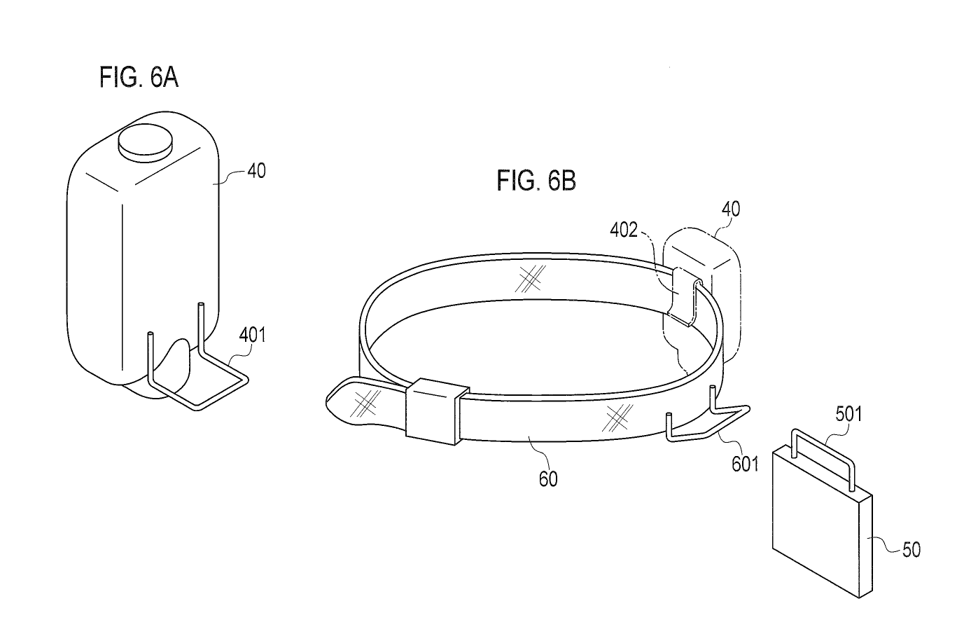

In addition, in the robot system 1 according to the present embodiment, as illustrated in FIG. 6A, a hook portion 401 may be provided configured to be capable of hooking the teaching device 50 on the second wireless device 40.

According to this configuration, there is an effect that the operator 2 hooks on the hook portion 401 a hook 501 provided at an arbitrary position such as the upper surface of the teaching device 50, and hooks on the belt 60 a hook 402 provided at an arbitrary position such as the back surface of the second wireless device 40, thereby being able to perform operation with both hands, so that the convenience of operation by the operator is improved. Note that, the hook 402 and the hook 501 may be made of metallic parts, plastic, or the like.

Alternatively, in the robot system 1 according to the present embodiment, as illustrated in FIG. 6B, a hook portion 601 may be provided configured to be capable of hooking the teaching device 50 on the belt 60.

According to this configuration, there is an effect that the operator 2 hooks on the hook portion 601 the hook 501 provided at an arbitrary position such as the upper surface of the teaching device 50, and hooks on the belt 60 the hook 402 provided at an arbitrary position such as the back surface of the second wireless device 40, thereby being able to perform operation with both hands, so that the convenience of operation by the operator is improved.

Note that, the second wireless device 40 and the belt 60 may be connected by a wire such as a cable or may be connected by a metal surface contact.

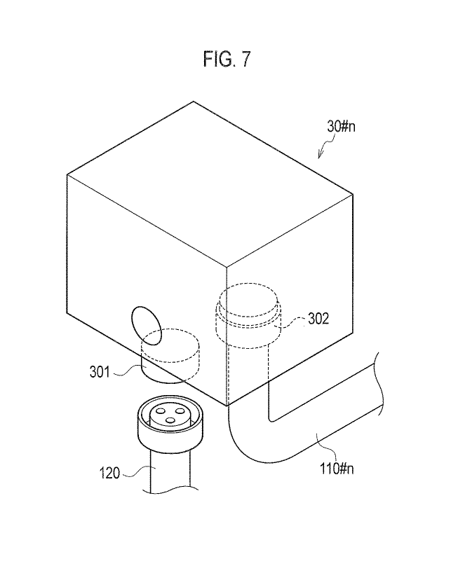

In addition, in the robot system 1 according to the present embodiment, as illustrated in FIG. 7, the first wireless devices 30#n may further include a connector 301 connectable to the teaching device 50 via the wire 120, in addition to a connector 302 connectable to the controller 20#n via the corresponding wire 110#n.

The connector 301 may be provided at an arbitrary position of the first wireless device 30#n. In addition, the connector 301 may be configured to be connectable to the wire 120 used for connection between the teaching device 50 and the second wireless device 40, or may be configured to be connectable to another wire.

According to this feature, the first wireless device 30#n can function as a wired repeater between the controller 20#n and the teaching device 50. Therefore, for example, in a case where the radio wave condition is bad, the controller 20#n can be connected to the teaching device 50 by wire without intervention of the second wireless device 40. In this case, even in a case where the controller 20#n is arranged away from the robot 10#n as illustrated in FIG. 1 and wireless communication cannot be established between the first wireless device 30#n and the second wireless device for some reason, the controller 20#n can be easily and reliably connected to the teaching device 50, so that it is possible to control the desired robot 10#n.

Clearly, other modifications and manners of practicing this invention will occur readily to those of ordinary skill in the art in view of these teachings. The above description is illustrative and not restrictive. This invention is to be limited only by the following claims, which include all such modifications and manners of practice when viewed in conjunction with the above specification and accompanying drawings. The scope of the invention should, therefore, be determined not with reference to the above description, but instead should be determined with reference to the appended claims along with their full scope of equivalents.

1. A robot system comprising:
a robot;
a controller connected to the robot via a wired line, and configured to control the robot;
a first wireless device connected to the controller via a wired line; and
a teaching device configured to be capable of communicating with the first wireless device, capable of being grasped and operated by an operator, and configured to control the robot via the controller in accordance with operation of the operator, wherein
a distance between a position where the robot is arranged and a position where the controller is arranged is longer than a distance between the position where the robot is arranged and a position where the first wireless device is arranged.

2. The robot system according to claim 1, wherein
the first wireless device comprises a connector connectable to the teaching device via a wired line.

3. The robot system according to claim 1, wherein
a plurality of the robots is provided,
a plurality of the first wireless devices that controls the respective plurality of robots is provided, wherein number of the first wireless devices is identical to number of the robots, and
arrangement order of the robots is arranged to be identical to arrangement order of the first wireless devices corresponding to the respective robots.

4. The robot system according to claim 3, wherein
the teaching device is configured to be capable of performing short-range communication with the first wireless device, and
when the teaching device transmits a predetermined signal to the first wireless device via the short-range communication, a new connection is established between the teaching device and the first wireless device.

5. The robot system according to claim 1, further comprising:
a second wireless device connected to the teaching device via a wired line, and configured to wirelessly relay communication between the first wireless device and the teaching device; and
a belt for fixing the second wireless device around a waist of an operator, wherein
an antenna for communicating with the first wireless device is provided on each of the second wireless device and the belt, and
the second wireless device is connectable to the antenna provided on the belt.

6. The robot system according to claim 5, wherein
a hook portion configured to be capable of hooking the teaching device is provided on at least one of the second wireless device and the belt.

7. A remote control system comprising:
a controller configured to control a robot;
a first wireless device connected to the controller;
a teaching device capable of being grasped and operated by an operator, and configured to control the robot via the controller in accordance with operation of the operator;
a second wireless device connected to the teaching device; and
a belt for fixing the second wireless device around a waist of the operator, wherein
an antenna for communicating with the first wireless device is provided on each of the second wireless device and the belt, and
the second wireless device is connectable to the antenna provided on the belt.

8. The remote control system according to claim 7, wherein
a hook portion configured to be capable of hooking the teaching device is provided on at least one of the second wireless device and the belt.
